(19) United States
(12) Patent Application Publication
(10) Pub. No.: US 2012/0234008 A1
(43) Pub. Date: Sep. 20, 2012

(54) GAS SUPPLY DEVICE AND EXHAUST GAS POWER GENERATION SYSTEM

(76) Inventor: Chikara Ohki, Kuwana-shi (JP)

(21) Appl. No.: 13/512,761

(22) PCT Filed: Nov. 26, 2010
(86) PCT No.: PCT/JP2010/071122

§ 371 Date: May 30, 2012

(30) Foreign Application Priority Data
Nov. 30, 2009 (JP) 2009-271661

(51) Int. Cl. F02C 1/05; F23J 11/00

(52) U.S. Cl. 60/682; 110/203; 110/210

(57) ABSTRACT

A gas supply device includes a first flow channel connecting a heat-treating furnace and a power generation device, a pressure control valve arranged in the first flow channel for controlling a pressure of exhaust gas flowing through the first flow channel, and a furnace pressure gauge measuring a pressure within the heat-treating furnace. If the pressure within the heat-treating furnace measured by the furnace pressure gauge becomes lower than a predetermined value, the pressure control valve controls the pressure of the exhaust gas to increase the pressure of the exhaust gas within the first flow channel.

### TECHNICAL FIELD

The present invention relates to a gas supply device and an exhaust gas power generation system, and more particularly to a gas supply device supplying exhaust gas exhausted from a heat-treating furnace to a power generation device, and an exhaust gas power generation system including the gas supply device.

### BACKGROUND ART

In a heat-treating furnace, a flammable gas may be used as an atmosphere for heating a workpiece. In heat treatment such as carburizing, carbonitriding, and quench hardening in which a workpiece made of, for example, steel is heated in a temperature range equal to or higher than an austenitizing temperature, an endothermic converted gas derived from a hydrocarbon gas is generally used as an atmospheric gas.

By using the endothermic converted gas as an atmospheric gas, the amount of carbon on a surface of the workpiece can be controlled by the Boudouard reaction.

Generally, an endothermic converted gas can be produced by mixing a hydrocarbon gas and air at a high temperature (for example, about 1050° C.) in the presence of an Ni catalyst. The hydrocarbon gas commonly used as a raw material is CH₄ (methane), C₃H₈ (propane), C₄H₁₀ (butane), or a mixed gas thereof. For example, when C₃H₈ is used as a source gas, an endothermic converted gas having a volume fraction of CO (carbon monoxide) of 23.7%, a volume fraction of H₂ (hydrogen) of 31.6%, and a volume fraction of N₂ (nitrogen) of 44.6% is obtained (see, for example, Taizo Hara, “Design and Facts of Heat-Treating Furnace”, the revised second edition, Shin-Nihon Casting & Forging Press, 2005, p. 120 (Non Patent Literature 1)). CO and H₂ constituting the endothermic converted gas have flammability.

In typical heat treatment, an endothermic converted gas in an amount significantly larger than an amount which actually contributes to a reaction with a workpiece is supplied into a heat-treating furnace in order to maintain a pressure within the heat-treating furnace at a positive pressure (about 50 to 200 Pa in gauge pressure). As a result, the endothermic converted gas is exhausted from the heat-treating furnace as exhaust gas without significantly changing its composition. Since CO and H₂ are flammable gases as described above, if they are exhausted into the air without being treated, they may be mixed with oxygen in the air at a high temperature and cause an explosion or the like. Further, since CO has toxicity, it is not preferable to exhaust it directly into the air. Thus, a burner is provided near an exhaust port of the heat-treating furnace, and CO and H₂ contained in the endothermic converted gas are ignited by the burner, converted into CO₂ (carbon dioxide) and H₂O (water), respectively, and released into the air.

CO has a combustion heat of 283 kJ/mol, and H₂ has a combustion heat of 286 kJ/mol. That is, great energy is generated in the conversion of CO and H₂ into CO₂ and H₂O as described above. Accordingly, a power generation system is under consideration in which a gas compressor and a turbine engine are provided as power generation devices at a position downstream of an exhaust port of a heat-treating furnace to utilize a flammable gas in exhaust gas as a fuel. Further, there has been proposed a structure which allows a heat-treating furnace to be operated continuously even if driving of the power generation devices in such a power generation system is stopped or their operation statuses are changed, and the speed of supplying exhaust gas to the power generation devices (i.e., the supply amount per unit time) is decreased (see, for example, Japanese Patent Laying-Open No. 2008-57508 (Patent Literature 1)).

### CITATION LIST

### Patent Literature

PTL 1: Japanese Patent Laying-Open No. 2008-57508

### NON PATENT LITERATURE

NPL 1: Taizo Hara, “Design and Facts of Heat-Treating Furnace”, the revised second edition, Shin-Nihon Casting & Forging Press, 2005, p. 120

### SUMMARY OF INVENTION

### Technical Problem

The inventor of the present invention has conducted a detailed study in order to putting an exhaust gas power generation system which utilizes a flammable gas in exhaust gas as a fuel as described above, into practical use. As a result, the inventor has found that a problem as described below should be solved to put the exhaust gas power generation system into practical use.

Specifically, in order to perform power generation utilizing gas exhausted from a heat-treating furnace, it is necessary to avoid the power generation from affecting the stability of operation of the heat-treating furnace. Even if driving of the gas compressor and the turbine engine is stopped or their operation statuses are changed, and the speed of supplying exhaust gas to the power generation devices is decreased as described above, operation of the heat-treating furnace can be continued by adopting the structure described in Patent Literature 1. However, the study by the inventor of the present invention has revealed that there are cases where, even if the speed of supplying exhaust gas to the power generation devices is not decreased, it becomes difficult to continue operation of the heat-treating furnace.

As described above, the pressure within the heat-treating furnace is maintained at a pressure slightly higher than atmospheric pressure. This is intended to avoid occurrence of an explosion or the like caused by entrance of oxygen from outside into the heat-treating furnace having a high-temperature flammable gas. However, if the speed of supplying exhaust gas to the power generation devices is increased due to a change in the operation statuses of the power generation devices, the pressure within the heat-treating furnace may be a negative pressure. In this case, oxygen may enter the heat-treating furnace from outside and cause an explosion or the like. Therefore, it is necessary to solve this problem to put the above exhaust gas power generation system into practical use.

Thus, one object of the present invention is to provide a gas supply device and an exhaust gas power generation system capable of suppressing a reduction in a pressure within a heat-treating furnace.

### Solution to Problem

A gas supply device in accordance with one aspect of the present invention is a gas supply device supplying exhaust gas exhausted from a heat-treating furnace to a power generation device. The gas supply device includes a first flow channel connecting the heat-treating furnace and the power generation device, a pressure control portion arranged in the first flow channel for controlling a pressure of the exhaust gas flowing through the first flow channel, and a furnace pressure gauge measuring a pressure within the heat-treating furnace. If the pressure within the heat-treating furnace measured by the furnace pressure gauge becomes lower than a predetermined value, the pressure control portion controls the pressure of the exhaust gas to increase the pressure of the exhaust gas within the first flow channel.

Further, a gas supply device in accordance with another aspect of the present invention is a gas supply device supplying exhaust gas exhausted from a heat-treating furnace to a power generation device. The gas supply device includes a first flow channel connecting the heat-treating furnace and the power generation device, a pressure control portion arranged in the first flow channel for controlling a pressure of the exhaust gas flowing through the first flow channel, and a mass flow meter arranged in the first flow channel at a position upstream of the pressure control portion for measuring a mass flow rate of the exhaust gas flowing through the first flow channel. If the mass flow rate of the exhaust gas measured by the mass flow meter becomes higher than a predetermined value, the pressure control portion controls the pressure of the exhaust gas to increase the pressure of the exhaust gas within the first flow channel.

The gas supply device in accordance with another aspect described above may further include a furnace pressure gauge measuring a pressure within the heat-treating furnace. In this case, if the pressure within the heat-treating furnace measured by the furnace pressure gauge becomes lower than a predetermined value, the pressure control portion controls the pressure of the exhaust gas to increase the pressure of the exhaust gas within the first flow channel.

Further, a gas supply device in accordance with still another aspect of the present invention is a gas supply device supplying exhaust gas exhausted from a heat-treating furnace to a power generation device. The gas supply device includes a first flow channel connecting the heat-treating furnace and the power generation device, a pressure control portion arranged in the first flow channel for controlling a pressure of the exhaust gas flowing through the first flow channel, and a flow channel pressure gauge arranged in the first flow channel at a position upstream of the pressure control portion for measuring the pressure of the exhaust gas flowing through the first flow channel. If the pressure within the first flow channel measured by the flow channel pressure gauge becomes lower than a predetermined value, the pressure control portion controls the pressure of the exhaust gas to increase the pressure of the exhaust gas within the first flow channel.

The gas supply device in accordance with still another aspect described above may further include a mass flow meter arranged in the first flow channel at a position upstream of the pressure control portion for measuring a mass flow rate of the exhaust gas flowing through the first flow channel. In this case, if the mass flow rate of the exhaust gas measured by the mass flow meter becomes higher than a predetermined value, the pressure control portion controls the pressure of the exhaust gas to increase the pressure of the exhaust gas within the first flow channel.

The gas supply device in accordance with still another aspect described above may further include a furnace pressure gauge measuring a pressure within the heat-treating furnace. In this case, if the pressure within the heat-treating furnace measured by the furnace pressure gauge becomes lower than a predetermined value, the pressure control portion controls the pressure of the exhaust gas to increase the pressure of the exhaust gas within the first flow channel.

As described above, in the gas supply device in accordance with the present invention, in the first flow channel connecting the heat-treating furnace and the power generation device, the pressure control portion is arranged, and at least one of the furnace pressure gauge measuring the pressure within the heat-treating furnace, the mass flow meter measuring the mass flow rate of the exhaust gas upstream of the pressure control portion, and the flow channel pressure gauge measuring the pressure of the exhaust gas upstream of the pressure control portion is provided. If at least one of the furnace pressure gauge, the mass flow meter, and the flow channel pressure gauge has a measurement value indicating a reduction in the pressure within the heat-treating furnace, the pressure control portion increases the pressure of the exhaust gas within the first flow channel, and increases the pressure within the heat-treating furnace. As a result, according to the gas supply device in accordance with the present invention, even if the speed of consuming the exhaust gas is increased depending on, for example, an operation status of the power generation device, a reduction in the pressure within the heat-treating furnace can be suppressed.

Preferably, the gas supply device further includes a second flow channel branching off from the first flow channel at a position upstream of the pressure control portion for exhausting the exhaust gas to an outside, and a communication control valve arranged in the second flow channel for controlling communication and blocking between the second flow channel and the outside.

Thereby, if the speed of consuming the exhaust gas by the power generation device is decreased and at least one of the furnace pressure gauge, the mass flow meter, and the flow channel pressure gauge has a measurement value indicating an increase in the pressure within the heat-treating furnace, the gas supply device can cause the communication control valve to establish communication between the second flow channel and the outside, and can exhaust the exhaust gas from the second flow channel to the outside. As a result, the gas supply device can suppress a phenomenon that the pressure within the heat-treating furnace is increased and an atmospheric gas leaks from the heat-treating furnace.

Preferably, the gas supply device further includes a burner arranged to be adjacent to an external opening of the second flow channel for burning the exhaust gas exhausted from the opening.

Thereby, the gas supply device can burn the exhaust gas exhausted from the second flow channel, and render gas components having flammability and toxicity harmless.

Preferably, the gas supply device further includes a throttle arranged in the second flow channel for adjusting a pressure of the exhaust gas flowing through the second flow channel.

Thereby, the gas supply device can control a pressure within the second flow channel, and adjust the pressure within the heat-treating furnace when the exhaust gas is exhausted from the second flow channel, in a desired range.

Preferably, the gas supply device further includes a check valve arranged in the second flow channel for suppressing an external atmosphere from flowing from the outside into the first flow channel through the second flow channel.

Thereby, even if the pressure within the second flow channel becomes a negative pressure, the gas supply device can suppress oxygen contained in the external atmosphere from flowing into the heat-treating furnace through the second flow channel.

Preferably, the gas supply device further includes a compression blower arranged in the first flow channel at a position downstream of the pressure control portion for pressurizing the exhaust gas.

Thereby, the gas supply device can supply the exhaust gas in a pressurized state to the power generation device, and can contribute to stable combustion of the exhaust gas in the power generation device.

Preferably, the gas supply device further includes a gas holder arranged in the first flow channel at a position downstream of the compression blower for holding the exhaust gas pressurized by the compression blower.

Thereby, the gas supply device can temporarily hold the exhaust gas pressurized by the compression blower in the gas holder, and supply the exhaust gas in an amount required in the power generation device from the gas holder to the power generation device. As a result, the exhaust gas can be supplied to the power generation device in accordance with a change in the operation status of the power generation device, without affecting the pressure within the heat-treating furnace.

Preferably, the gas supply device further includes a supply blower arranged in the first flow channel at a position downstream of the gas holder for pressurizing the exhaust gas within the gas holder and supplying it to the power generation device.

Thereby, the gas supply device can supply the exhaust gas within the gas holder in a more pressurized state to the power generation device, and as a result can further stabilize combustion of the exhaust gas in the power generation device.

An exhaust gas power generation system in accordance with the present invention includes a heat-treating furnace, a power generation device, and a gas supply device supplying exhaust gas exhausted from the heat-treating furnace to the power generation device. The gas supply device is a gas supply device in accordance with the present invention as described above.

Since the exhaust gas power generation system in accordance with the present invention includes the gas supply device in accordance with the present invention capable of suppressing a reduction in the pressure within the heat-treating furnace, it can generate electric power utilizing exhaust gas while suppressing a reduction in the pressure within the heat-treating furnace.

### ADVANTAGEOUS EFFECTS OF INVENTION

As is clear from the above description, according to the gas supply device and the exhaust gas power generation system in accordance with the present invention, a gas supply device and an exhaust gas power generation system capable of suppressing a reduction in a pressure within a heat-treating furnace can be provided.

### BRIEF DESCRIPTION OF DRAWINGS

FIG. 1 is a schematic diagram showing a configuration of an exhaust gas power generation system.

FIG. 2 is a schematic diagram showing a configuration of an exhaust gas power generation system in Embodiment 2.

FIG. 3 is a schematic diagram showing a configuration of an exhaust gas power generation system in Embodiment 3.

FIG. 4 is a schematic diagram showing a structure of an experiment device.

FIG. 5 is a view showing the relationship between elapsed time and pressure within a heat-treating furnace.

FIG. 6 is a view showing the relationship between elapsed time and pressure within the heat-treating furnace.

### DESCRIPTION OF EMBODIMENTS

Hereinafter, embodiments of the present invention will be described with reference to the drawings, in which identical or corresponding parts will be designated by the same reference numerals, and the description thereof will not be repeated.

### Embodiment 1

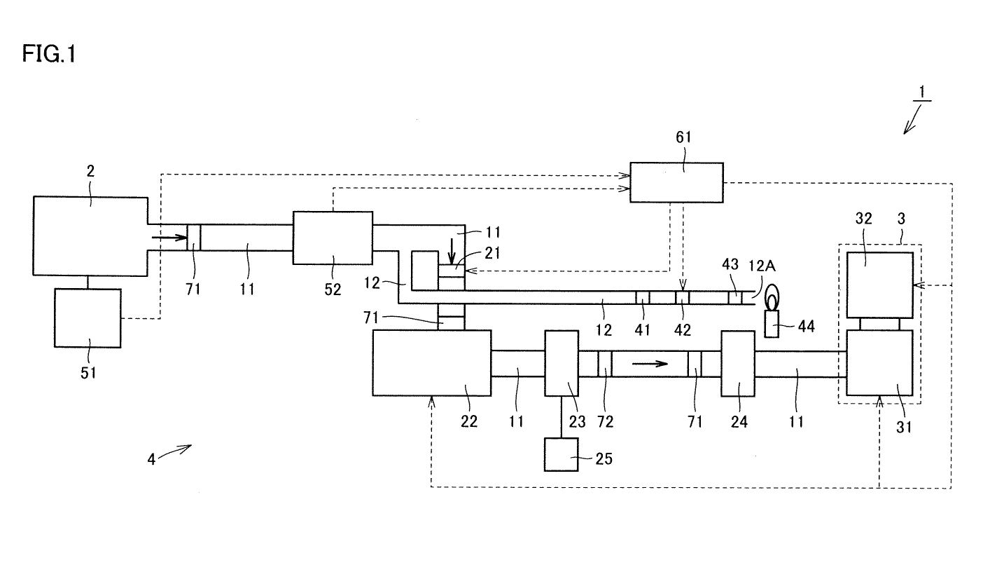

Firstly, a gas supply device in Embodiment 1 as one embodiment of the present invention, and an exhaust gas power generation system including the gas supply device will be described with reference to FIG. 1. In FIGS. 1 to 4 below, a solid line arrow indicates a flow of exhaust gas, and a broken line arrow indicates a flow of a control signal. Referring to FIG. 1, an exhaust gas power generation system 1 in the present embodiment includes a heat-treating furnace 2 to which an endothermic converted gas is supplied from an atmospheric gas supply source (not shown) to heat-treat a workpiece made of, for example, steel, a power generation device 3, and a gas supply device 4 supplying exhaust gas containing CO and H₂ exhausted from heat-treating furnace 2 to power generation device 3. Gas supply device 4 includes a first flow channel 11 connecting heat-treating furnace 2 and power generation device 3, a pressure control valve 21 serving as a pressure control portion arranged in first flow channel 11 for controlling a pressure of the exhaust gas flowing through first flow channel 11, a furnace pressure gauge 51 measuring a pressure within heat-treating furnace 2, and a mass flow meter 52 arranged in first flow channel 11 at a position upstream of pressure control valve 21 for measuring a mass flow rate of the exhaust gas flowing through first flow channel 11.

Power generation device 3 includes a gas engine 31 which rotates a turbine by combustion of the exhaust gas and converts thermal energy generated by the combustion into kinetic energy, and a power generator 32 which is connected to gas engine 31 and converts the kinetic energy generated in gas engine 31 into electrical energy. First flow channel 11 is connected to gas engine 31.

If the pressure within heat-treating furnace 2 measured by furnace pressure gauge 51 becomes lower than a predetermined value, pressure control valve 21 increases the pressure of the exhaust gas within first flow channel 11 by decreasing an amount of the exhaust gas passing through pressure control valve 21 or by preventing the exhaust gas from passing through pressure control valve 21. Similarly, if the mass flow rate of the exhaust gas measured by mass flow meter 52 becomes higher than a predetermined value, pressure control valve 21 also increases the pressure of the exhaust gas within first flow channel 11.

With such a structure, gas supply device 4 in the present embodiment can suppress a reduction in the pressure within heat-treating furnace 2 even if the speed of consuming the exhaust gas is increased depending on, for example, an operation status of power generation device 3.

Further, gas supply device 4 in the present embodiment includes a compression blower 22 arranged in first flow channel 11 at a position downstream of pressure control valve 21 for pressurizing the exhaust gas. Although compression blower 22 is not indispensable for the gas supply device in accordance with the present invention, gas supply device 4 in the present embodiment having compression blower 22 can supply the exhaust gas in a pressurized state to power generation device 3, and can contribute to stable combustion of the exhaust gas in power generation device 3.

Further, gas supply device 4 in the present embodiment includes a gas holder 23 arranged in first flow channel 11 at a position downstream of compression blower 22 for holding the exhaust gas pressurized by compression blower 22. Although gas holder 23 is also not indispensable for the gas supply device in accordance with the present invention, gas supply device 4 in the present embodiment having gas holder 23 can temporarily hold the exhaust gas pressurized by compression blower 22 in gas holder 23, and supply the exhaust gas in an amount required in power generation device 3 from gas holder 23 to power generation device 3. As a result, the exhaust gas can be supplied to power generation device 3 in accordance with a change in the operation status of power generation device 3, without affecting the pressure within heat-treating furnace 2. In addition, a filling rate indicator 25 is connected to gas holder 23 to allow measurement of a filling rate of the exhaust gas with respect to a specified capacity of gas holder 23.

Further, gas supply device 4 in the present embodiment includes a supply blower 24 arranged in first flow channel 11 at a position downstream of gas holder 23 for pressurizing the exhaust gas within gas holder 23 and supplying it to power generation device 3. Although supply blower 24 is also not indispensable for the gas supply device in accordance with the present invention, gas supply device 4 in the present embodiment having supply blower 24 can supply the exhaust gas within gas holder 23 in a more pressurized state to power generation device 3, and thus can further stabilize combustion of the exhaust gas in power generation device 3.

Further, gas supply device 4 in the present embodiment includes a second flow channel 12 branching off from first flow channel 11 at a position upstream of pressure control valve 21 and downstream of mass flow meter 52 for exhausting the exhaust gas to an outside, and a solenoid valve 42 serving as a communication control valve arranged in second flow channel 12 for controlling communication and blocking between second flow channel 12 and the outside. Although second flow channel 12 and solenoid valve 42 are also not indispensable for the gas supply device in accordance with the present invention, if the speed of consuming the exhaust gas by power generation device 3 is decreased and at least one of furnace pressure gauge 51 and mass flow meter 52 has a measurement value indicating an increase in the pressure within heat-treating furnace 2, gas supply device 4 in the present embodiment having second flow channel 12 and solenoid valve 42 can cause solenoid valve 42 to establish communication between second flow channel 12 and the outside, and can exhaust the exhaust gas from second flow channel 12 to the outside. As a result, gas supply device 4 can suppress a phenomenon that the pressure within heat-treating furnace 2 is increased and an atmospheric gas leaks from heat-treating furnace 2.

Further, gas supply device 4 in the present embodiment includes a burner 44 arranged to be adjacent to an external opening 12A of second flow channel 12 for burning the exhaust gas exhausted from opening 12A. Although burner 44 is also not indispensable for the gas supply device in accordance with the present invention, gas supply device 4 in the present embodiment having burner 44 can burn the exhaust gas exhausted from second flow channel 12 and render CO and H₂, which are gas components having flammability and toxicity, harmless.

Further, gas supply device 4 in the present embodiment includes a throttle 41 arranged in second flow channel 12 for adjusting a pressure of the exhaust gas flowing through second flow channel 12. Although throttle 41 is also not indispensable for the gas supply device in accordance with the present invention, gas supply device 4 in the present embodiment having throttle 41 can control a pressure within second flow channel 12, and adjust the pressure within heat-treating furnace 2 when the exhaust gas is exhausted from second flow channel 12, in a desired range. Further, gas supply device 4 in the present embodiment includes a check valve 43 arranged in second flow channel 12 for suppressing an external atmosphere from flowing from the outside into first flow channel 11 through second flow channel 12. Although check valve 43 is also not indispensable for the gas supply device in accordance with the present invention, in gas supply device 4 in the present embodiment having check valve 43, even if the pressure within second flow channel 12 becomes a negative pressure, oxygen contained in the external atmosphere is suppressed from flowing into heat-treating furnace 2 through second flow channel 12.

Further, as shown in FIG. 1, first flow channel 11 can be provided with a filter 71 for removing soot and the like contained in the exhaust gas, and a mist separator 72 for removing water and the like contained in the exhaust gas. This suppresses soot, water, and the like in the exhaust gas from flowing into the gas engine.

Next, an operation of exhaust gas power generation system 1 in Embodiment 1 will be described, based on an exemplary case where a workpiece made of steel is heated in the temperature range equal to or higher than the austenitizing temperature in an endothermic converted gas atmosphere and heat-treated. Referring to FIG. 1, firstly, with the workpiece being placed in heat-treating furnace 2, the endothermic converted gas is supplied from the atmospheric gas supply source (not shown) such as a conversion furnace into heat-treating furnace 2, and the workpiece is heated to a desired temperature and heat-treated. On this occasion, exhaust gas containing CO gas and H₂ gas as flammable gases is exhausted in a state cooled down to almost room temperature from the heat-treating furnace, and flows into first flow channel 11 at a flow rate of, for example, 10 Nm³/h. Further, since the pressure within heat-treating furnace 2 is maintained at a positive pressure (i.e., a pressure higher than atmospheric pressure), the exhaust gas also has a positive pressure of about 50 to 200 Pa, for example, a positive pressure of 100 Pa (gauge pressure). On the other hand, furnace pressure gauge 51 is provided to heat-treating furnace 2 to monitor the pressure within heat-treating furnace 2.

Since the exhaust gas exhausted from heat-treating furnace 2 has a composition substantially identical to that of the endothermic converted gas, when it is cooled down to almost room temperature, soot (graphite) precipitates. Thus, the exhaust gas flowing into first flow channel 11 firstly passes through filter 71 arranged near a flow-in port, and thereby soot is removed. Next, the exhaust gas passing through filter 71 passes through mass flow meter 52. Then, mass flow meter 52 monitors the mass flow rate of the exhaust gas.

The exhaust gas passing through mass flow meter 52 passes through pressure control valve 21 and another filter 71 to reach compression blower 22, and is pressurized to, for example, about 1 kPa. As pressure control valve 21, the one which can perform fine differential pressure control is adopted. Further, as pressure control valve 21, the one having a high opening/closing speed is preferably adopted, and for example, an air-type valve can be adopted. Here, since the exhaust gas is pressurized by compression blower 22, the exhaust gas upstream of compression blower 22 (on a side provided with heat-treating furnace 2) is suctioned toward compression blower 22. On this occasion, if the pressure within heat-treating furnace 2 becomes a negative pressure, oxygen may flow from the outside into heat-treating furnace 2. Thus, if the furnace pressure gauge monitoring the pressure within the furnace has a measurement value lower than a predetermined value, or if the mass flow meter monitoring the mass flow rate of the exhaust gas upstream of compression blower 22 and pressure control valve 21 has a measurement value higher than a predetermined value, pressure control valve 21 operates to decrease the amount of the exhaust gas passing through pressure control valve 21 or prevent the exhaust gas from passing through pressure control valve 21, and increases the pressure of the exhaust gas within first flow channel 11. This avoids the pressure within heat-treating furnace 2 from becoming a negative pressure. The exhaust gas pressurized by compression blower 22 is held in gas holder 23 arranged downstream of compression blower 22 (on a side provided with power generation device 3). As gas holder 23, the one having, for example, a withstanding pressure of about 15 MPa and a capacity of about 50 L can be adopted. Further, filling rate indicator 25 is provided to gas holder 23 to monitor the filling rate. The exhaust gas held within gas holder 23 is further pressurized by supply blower 24 arranged downstream, for example to about 50 kPa, and supplied as a fuel to gas engine 31. On this occasion, the exhaust gas passes through mist separator 72 and another filter 71 to reach supply blower 24, and thereby water, soot, and the like are removed. This suppresses water, soot, and the like from entering gas engine 31. Then, the exhaust gas is used as a fuel in gas engine 31, and power generator 32 is operated to achieve power generation. Electrical energy obtained as described above can be used, for example, as energy for maintaining heat-treating furnace 2 at a constant temperature, and the like.

On the other hand, if a failure or the like occurs in a flow of the power generation described above, a fail-safe mechanism described below is operated. For example, if the speed of consuming the exhaust gas by power generation device 3 is decreased or stopped, solenoid valve 42, which is in a closed state during normal operation, is switched to an open state. Thereby, communication is established between a region in first flow channel 11 downstream of mass flow meter 52 and upstream of pressure control valve 21 and the outside, through second flow channel 12. On this occasion, by the action of throttle 41, the pressure within second flow channel 12 is 100 Pa (gauge pressure) and the exhaust gas has a flow rate of 10 Nm³/h, for example. As a result, the exhaust gas is kept exhausted from heat-treating furnace 2 at a pressure of 100 Pa (gauge pressure) and a flow rate of 10 Nm³/h, without being affected by the failure which occurs in the flow of the power generation described above. Then, CO and H₂ in the exhaust gas exhausted from opening 12A of second flow channel 12 are ignited by burner 44, converted into CO₂ and H₂O, respectively, and rendered harmless, and thereafter released into the air.

The operation of exhaust gas power generation system 1 as described above is controlled by a control unit 61 storing a program for an operation for example as described below. Firstly, before exhaust gas power generation system 1 is started up, the above fail-safe mechanism is in operation, and solenoid valve 42 provided in second flow channel 12 is in an open state, and pressure control valve 21 is in a closed state. Then, when exhaust gas power generation system 1 is started up, in response to a control signal from control unit 61, compression blower 22 is operated, pressure control valve 21 is switched to an open state, and solenoid valve 42 is switched to a closed state. Further, when the filling rate of gas holder 23 reaches, for example, 50%, supply blower 24, gas engine 31, and power generator 32 are operated to start power generation.

When exhaust gas power generation system 1 in operation is stopped, in response to a control signal from control unit 61, compression blower 22, supply blower 24, gas engine 31, and power generator 32 are stopped. Then, solenoid valve 42 is switched to an open state, and pressure control valve 21 is switched to a closed state.

On the other hand, for example, if mass flow meter 52 indicates a value deviating from a target value by more than ±30% or if furnace pressure gauge 51 indicates a value deviating from a target value by more than ±30% while exhaust gas power generation system 1 is in operation, in response to a control signal from control unit 61 receiving this information, compression blower 22, supply blower 24, gas engine 31, and power generator 32 are stopped. Further, solenoid valve 42 is switched to an open state, and pressure control valve 21 is switched to a closed state. Then, after a lapse of, for example, 10 minutes, the indicated values of mass flow meter 52 and furnace pressure gauge 51 are confirmed. If these indicated values are not within, for example, ±5% from the target values, the indicated values of mass flow meter 52 and furnace pressure gauge 51 are confirmed again after a lapse of another 10 minutes. On the other hand, if it is confirmed that these indicated values are within, for example, ±5% from the target values, in response to a control signal from control unit 61 receiving this information, compression blower 22 is operated, pressure control valve 21 is switched to an open state, and solenoid valve 42 is switched to a closed state. Further, if the filling rate of gas holder 23 is measured by filling rate indicator 25 and it is confirmed that the filling rate reaches, for example, 50%, in response to a control signal from control unit 61 receiving this information, supply blower 24, gas engine 31, and power generator 32 are started again for operation.

Further, if the filling rate of gas holder 23 measured by filling rate indicator 25 becomes, for example, less than 20% while exhaust gas power generation system 1 is in operation, in response to a control signal from control unit 61 receiving this information, supply blower 24, gas engine 31, and power generator 32 are stopped. Thereafter, if it is confirmed that the filling rate reaches, for example, 50%, in response to a control signal from control unit 61 receiving this information, supply blower 24, gas engine 31, and power generator 32 are operated again.

Further, if the filling rate of gas holder 23 measured by filling rate indicator 25 becomes, for example, not less than 110% while exhaust gas power generation system 1 is in operation, in response to a control signal from control unit 61 receiving this information, compression blower 22, supply blower 24, gas engine 31, and power generator 32 are stopped, and solenoid valve 42 is switched to an open state and pressure control valve 21 is switched to a closed state. Thereafter, if it is confirmed that the filling rate is reduced to, for example, 50%, in response to a control signal from control unit 61 receiving this information, solenoid valve 42 is switched to a closed state and pressure control valve 21 is switched to an open state, and compression blower 22, supply blower 24, gas engine 31, and power generator 32 are operated.

It is to be noted that, although Embodiment 1 has described a case where pressure control valve 21 is provided as a pressure control portion, from the viewpoint of reducing the number of parts, for example, pressure control valve 21 may be omitted, and compression blower 22 may be connected to a control device that can control compression blower 22 with an inverter and utilized as a pressure control portion. Further, although Embodiment 1 has described a case where both furnace pressure gauge 51 monitoring the pressure within heat-treating furnace 2 and mass flow meter 52 monitoring the mass flow rate of the exhaust gas exhausted from heat-treating furnace 2 are provided, the same operation can also be achieved by adopting either one of these components. However, from the viewpoint of ensuring higher safety, it is preferable to provide both components as described above.

### Embodiment 2

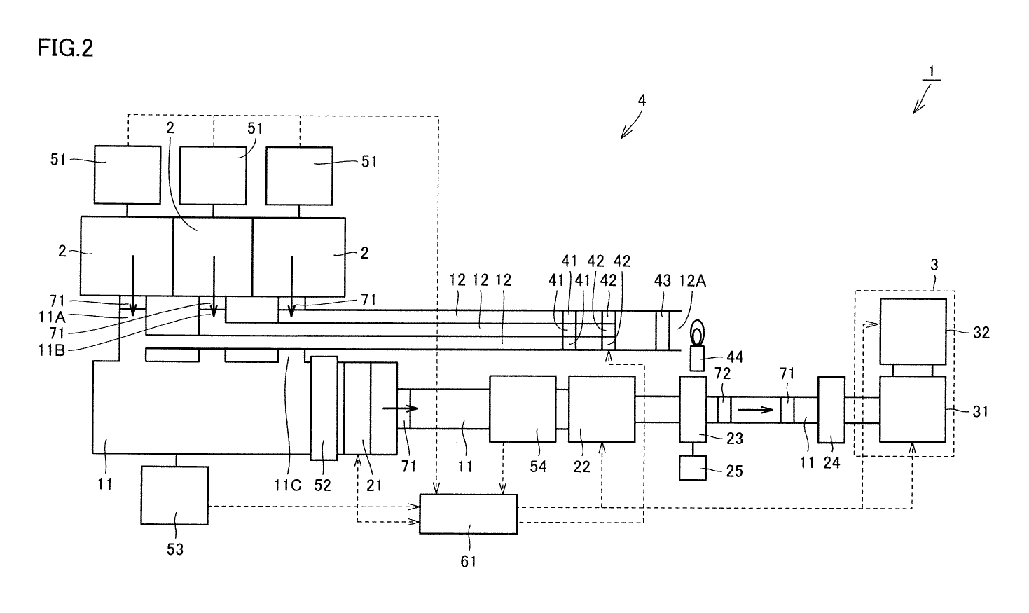

Next, Embodiment 2 as another embodiment of the present invention will be described. Referring to FIG. 2, each of exhaust gas power generation system 1 and gas supply device 4 in Embodiment 2 basically has the same structure, is operated in the same manner, and exhibits the same effect as those in Embodiment 1. However, exhaust gas power generation system 1 in Embodiment 2 has a plurality of (i.e., three) heat-treating furnaces, and accordingly gas supply device 4 has a structure different from that in Embodiment 1.

Specifically, first flow channel 11 of gas supply device 4 in Embodiment 2 includes three flow channels 11A, 11B, and 11C at connection portions with three heat-treating furnaces 2, and three flow channels 11A, 11B, and 11C are connected to three heat-treating furnaces 2, respectively. Three flow channels 11A, 11B, and 11C join at a downstream position into one first flow channel 11. As in Embodiment 1, mass flow meter 52, pressure control valve 21, compression blower 22, and the like are provided in first flow channel 11 at positions downstream of a junction.

In addition, a flow channel pressure gauge 53 measuring a pressure of the exhaust gas flowing through first flow channel 11 is arranged in first flow channel 11 at a position downstream of the junction and upstream of mass flow meter 52. Information of the pressure of the exhaust gas flowing through first flow channel 11 measured by flow channel pressure gauge 53 is transmitted to control unit 61. Then, in response to a control signal from control unit 61 receiving this information, operations of pressure control valve 21 and compression blower 22 are controlled. Specifically, if a measurement value of the pressure measured by flow channel pressure gauge 53 is lower than a predetermined value, pressure control valve 21 serving as a pressure control portion and compression blower 22 are operated to increase the pressure within first flow channel 11. Further, a second mass flow meter 54 is arranged in first flow channel 11 at a position downstream of pressure control valve 21 and upstream of compression blower 22. Information of a mass flow rate measured by second mass flow meter 54 is also transmitted to control unit 61.

On the other hand, second flow channel 12 branches off from each of three flow channels 11A, 11B, and 11C of first flow channel 11. In each second flow channel 12, throttle 41 and solenoid valve 42 as those in Embodiment 1 are arranged in this order from an upstream side (side provided with the heat-treating furnace). At a further downstream position, three second flow channels 12 corresponding to three flow channels 11A, 11B, and 11C join into one second flow channel 12. At a position downstream of a junction, check valve 43 as that in Embodiment 1 is arranged.

With such a structure, gas supply device 4 in Embodiment 2 can supply exhaust gas exhausted from a plurality of (three) heat-treating furnaces 2 to power generation device 3.

### Embodiment 3

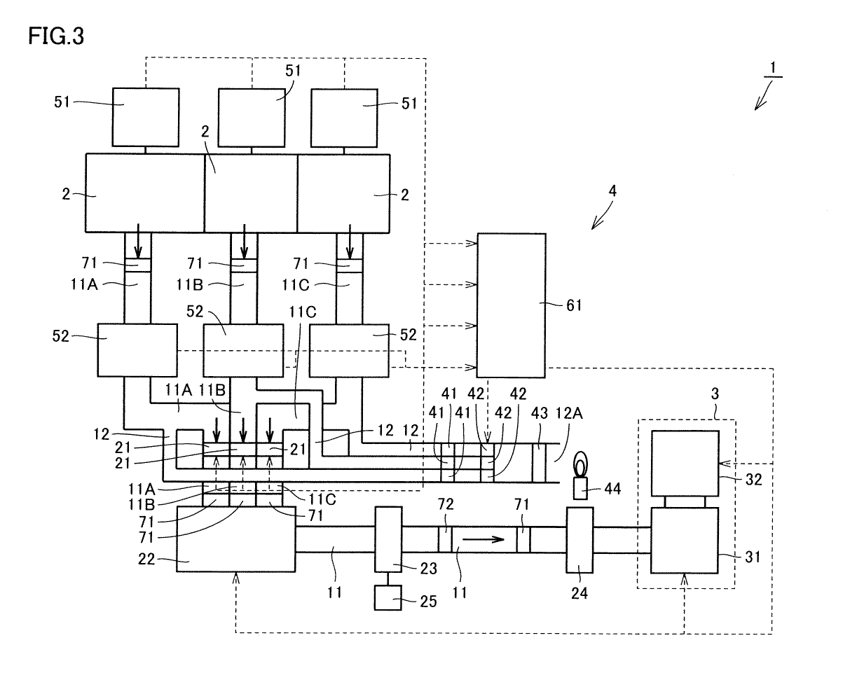

Next, Embodiment 3 as still another embodiment of the present invention will be described. Referring to FIG. 3, each of exhaust gas power generation system 1 and gas supply device 4 in Embodiment 3 basically has the same structure as that in Embodiment 2. However, gas supply device 4 in Embodiment 3 is different from that in Embodiment 2 in that mass flow meter 52 and pressure control valve 21 are arranged in each of three flow channels 11A, 11B, and 11C.

By including pressure control valve 21 serving as a pressure control portion corresponding to each of three heat-treating furnaces 2 as described above, gas supply device 4 in Embodiment 3 can independently control a pressure within each of a plurality of heat-treating furnaces 2. It is to be noted that, when there is no need to independently control the pressure within each of the plurality of heat-treating furnaces 2, the number of parts can be reduced and cost reduction of the gas supply device can be achieved by adopting the structure in Embodiment 2.

Each of exhaust gas power generation system 1 and gas supply device 4 in Embodiment 3 is operated in the same manner and exhibits the same effect as those in Embodiments 1 and 2. Further, either one or a combination of two or more of furnace pressure gauge 51, mass flow meter 52, and flow channel pressure gauge 53 described in the above embodiments can be provided to gas supply device 4.

### EXAMPLE

In order to allow the gas supply device in accordance with the present invention to perform a desired function, it is necessary that the pressure within the heat-treating furnace can be appropriately controlled by the pressure control portion. Thus, an experiment device having the same structure as that of the gas supply device in accordance with the present invention was prepared to perform an experiment for confirming that the pressure within the heat-treating furnace can be appropriately controlled by the pressure control portion. The experiment was conducted as described below.

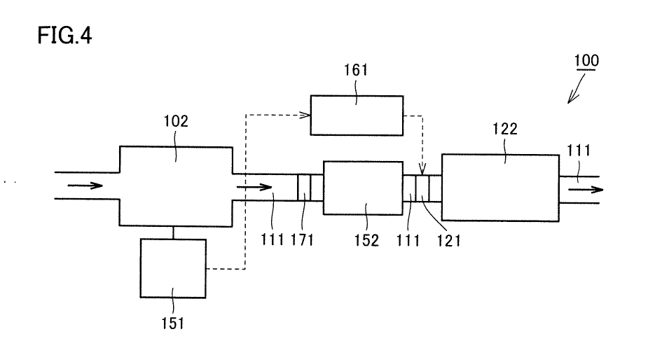

Firstly, the experiment device will be described with reference to FIG. 4. An experiment device 100 includes a heat-treating furnace 102 from which a throttle for adjusting a furnace pressure to be provided at an exhaust port has been removed; a flow channel 111 serving as a tube connected to the exhaust port of heat-treating furnace 102; a filter 171, a mass flow meter 152, a pressure control valve 121 serving as a pressure control portion, and a compression blower 122 provided in flow channel 111 in this order from an upstream side (side close to heat-treating furnace 102); a furnace pressure gauge 151 provided to heat-treating furnace 102; and a control unit 161 receiving information from furnace pressure gauge 151 and controlling pressure control valve 121.

Nitrogen (N₂) gas was supplied into heat-treating furnace 102 at flow rates in three levels, that is, 5, 10, and 15 Nm³/h, and the pressure within heat-treating furnace 102 was controlled such that a pressure of 50 Pa and a pressure of 150 Pa were repeated at an interval of three minutes or six minutes, and thus the experiment was conducted under a total of six conditions (Experiment Nos. 1 to 6). In each experimental condition, the heating temperature in heat-treating furnace 102 was set to 940° C. The experiment was conducted for 30 minutes to record changes in the pressure within heat-treating furnace 102. Table 1 shows concrete experimental conditions.

TABLE 1

| Experiment | Amount of N₂ Flowing into | Interval of Changing |
|---|---|---|
| No. | Furnace (Nm³/h) | Pressure (min) |
| 1 | 5 | 3 |
| 2 | 5 | 6 |
| 3 | 10 | 3 |
| 4 | 10 | 6 |
| 5 | 15 | 3 |
| 6 | 15 | 6 |

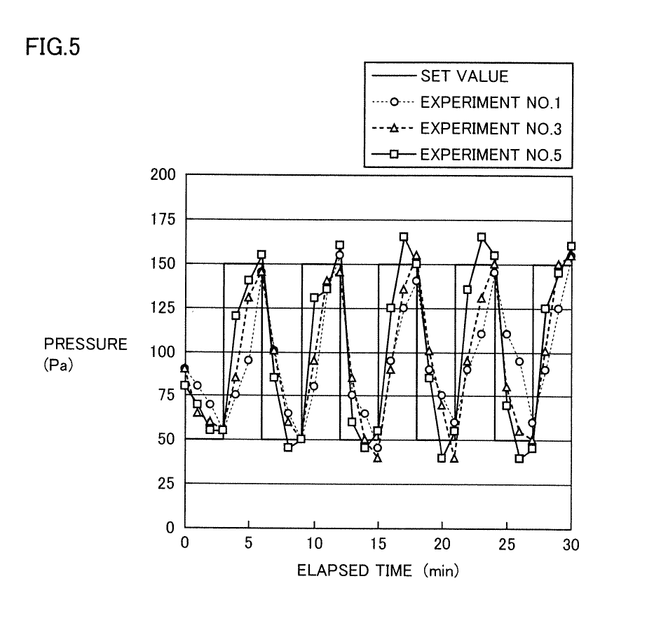

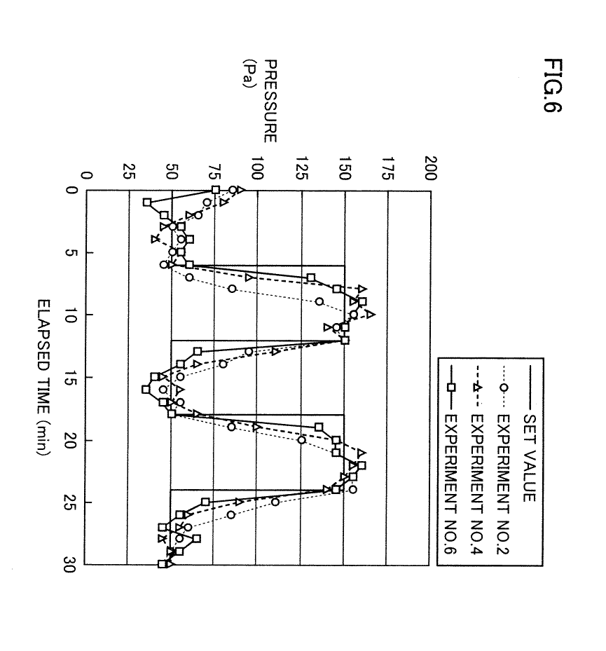

Next, experimental results will be described with reference to FIGS. 5 and 6. In FIGS. 5 and 6, the axis of abscissas represents elapsed time, and the axis of ordinates represents pressure within the furnace. Referring to FIGS. 5 and 6, the smaller the amount of nitrogen flowing into the furnace is, the slower the pressure within heat-treating furnace 102 follows a set value. However, even under the conditions of Experiment Nos. 1 and 2 in which the pressure follows the set value most slowly, the pressure within the heat-treating furnace becomes substantial equal to the set value within three minutes. Further, as a result of measurement by mass flow meter 152, it was found that the flow rate of the nitrogen gas was appropriately adjusted and the nitrogen gas in an amount substantially equal to the amount flowing into heat-treating furnace 102 was exhausted. The above experimental results have confirmed that the gas supply device in accordance with the present invention having the pressure control portion can appropriately suppress the pressure within the heat-treating furnace.

It should be understood that the embodiments and example disclosed herein are illustrative and non-restrictive in every respect. The scope of the present invention is defined by the scope of the claims, rather than the description above, and is intended to include any modifications within the scope and meaning equivalent to the scope of the claims.

### INDUSTRIAL APPLICABILITY

The gas supply device and the exhaust gas power generation system in accordance with the present invention are particularly advantageously applicable to a gas supply device supplying exhaust gas exhausted from a heat-treating furnace to a power generation device, and an exhaust gas power generation system including the gas supply device.

### REFERENCE SIGNS LIST

1: exhaust gas power generation system, 2: heat-treating furnace, 3: power generation device, 4: gas supply device, 11: first flow channel, 11A, 11B, 11C: flow channel, 12: second flow channel, 12A: opening, 21: pressure control valve, 22:

compression blower, 23 gas holder, 24: supply blower, 25: filling rate indicator, 31: gas engine, 32: power generator, 41: throttle, 42: solenoid valve, 43: check valve, 44: burner, 51: furnace pressure gauge, 52: mass flow meter, 53: flow channel pressure gauge, 54: second mass flow meter, 61: control unit, 71: filter, 72: mist separator, 100: experiment device, 102: heat-treating furnace, 111: flow channel, 121: pressure control valve, 122: compression blower, 151: furnace pressure gauge, 152: mass flow meter, 161: control unit, 171: filter.

1. A gas supply device supplying exhaust gas exhausted from a heat-treating furnace to a power generation device, comprising:
a first flow channel connecting said heat-treating furnace and said power generation device;
a pressure control portion arranged in said first flow channel for controlling a pressure of said exhaust gas flowing through said first flow channel; and
a furnace pressure gauge measuring a pressure within said heat-treating furnace,
wherein, if the pressure within said heat-treating furnace measured by said furnace pressure gauge becomes lower than a predetermined value, said pressure control portion controls the pressure of said exhaust gas to increase the pressure of said exhaust gas within said first flow channel.

2. The gas supply device according to claim 1, further comprising:
a second flow channel branching off from said first flow channel at a position upstream of said pressure control portion for exhausting said exhaust gas to an outside; and
a communication control valve arranged in said second flow channel for controlling communication and blocking between said second flow channel and the outside.

3. The gas supply device according to claim 2, further comprising a burner arranged to be adjacent to an external opening of said second flow channel for burning the exhaust gas exhausted from said opening.

4. The gas supply device according to claim 2, further comprising a throttle arranged in said second flow channel for adjusting a pressure of said exhaust gas flowing through said second flow channel.

5. The gas supply device according to claim 2, further comprising a check valve arranged in said second flow channel for suppressing an external atmosphere from flowing from the outside into said first flow channel through said second flow channel.

6. The gas supply device according to claim 1, further comprising a compression blower arranged in said first flow channel at a position downstream of said pressure control portion for pressurizing said exhaust gas.

7. The gas supply device according to claim 6, further comprising a gas holder arranged in said first flow channel at a position downstream of said compression blower for holding said exhaust gas pressurized by said compression blower.

8. The gas supply device according to claim 7, further comprising a supply blower arranged in said first flow channel at a position downstream of said gas holder for pressurizing the exhaust gas within said gas holder and supplying it to said power generation device.

9. An exhaust gas power generation system, comprising:
a heat-treating furnace;
a power generation device; and
a gas supply device supplying exhaust gas exhausted from said heat-treating furnace to said power generation device,
wherein said gas supply device is a gas supply device as recited in claim 1.

10. A gas supply device supplying exhaust gas exhausted from a heat-treating furnace to a power generation device, comprising:
a first flow channel connecting said heat-treating furnace and said power generation device;
a pressure control portion arranged in said first flow channel for controlling a pressure of said exhaust gas flowing through said first flow channel; and
a flow channel pressure gauge arranged in said first flow channel at a position upstream of said pressure control portion for measuring the pressure of said exhaust gas flowing through said first flow channel,
wherein, if the pressure within said first flow channel measured by said flow channel pressure gauge becomes lower than a predetermined value, said pressure control portion controls the pressure of said exhaust gas to increase the pressure of said exhaust gas within said first flow channel.

11. The gas supply device according to claim 10, further comprising a furnace pressure gauge measuring a pressure within said heat-treating furnace,
wherein, if the pressure within said heat-treating furnace measured by said furnace pressure gauge becomes lower than a predetermined value, said pressure control portion controls the pressure of said exhaust gas to increase the pressure of said exhaust gas within said first flow channel.

12. The gas supply device according to claim 10, further comprising a compression blower arranged in said first flow channel at a position downstream of said pressure control portion for pressurizing said exhaust gas.

13. The gas supply device according to claim 12, further comprising a gas holder arranged in said first flow channel at a position downstream of said compression blower for holding said exhaust gas pressurized by said compression blower.

14. The gas supply device according to claim 13, further comprising a supply blower arranged in said first flow channel at a position downstream of said gas holder for pressurizing the exhaust gas within said gas holder and supplying it to said power generation device.

15. An exhaust gas power generation system, comprising:
a heat-treating furnace;
a power generation device; and
a gas supply device supplying exhaust gas exhausted from said heat-treating furnace to said power generation device,
wherein said gas supply device is a gas supply device as recited in claim 10.
